(19) United States
(12) Patent Application Publication
(10) Pub. No.: US 2017/0368715 A1
(43) Pub. Date: Dec. 28, 2017

(54) Drill Ring for a Core Drill Bit and Method for Producing a Drill Ring

(71) Applicant: Hilti Aktiengesellschaft, Schaan (LI)

(72) Inventors: Matthias Mueller, Buchs (CH); Marcel Sonderegger, Balgach (CH)

(73) Assignee: Hilti Aktiengesellschaft, Schaan (LI)

(21) Appl. No.: 15/538,579

(22) PCT Filed: Dec. 22, 2015
(86) PCT No.: PCT/EP2015/080930

§ 371 Date: Jun. 21, 2017

(30) Foreign Application Priority Data
Dec. 22, 2014 (EP) 14199723.9

(51) Int. Cl. B28D 1/04; B23B 51/04; B23D 65/00

(52) U.S. Cl. CPC B28D 1/041; B23D 65/00; B23B 51/042; B23B 2226/31; B23B 2250/12

(57) ABSTRACT

A method for producing a drill ring for a core drill bit is disclosed. The method includes constructing at least two green parts from encapsulated diamond particles, the diamond particles being covered by a powder mixture. The green parts are formed into ring segments under the effect of pressure and the ring segments are annularly assembled and sintered under temperature action to form a continuous drill ring.

This application claims the priority of International Application No. PCT/EP2015/080930, filed Dec. 22, 2015, and European Patent Document No. 14199723.9, filed Dec. 22, 2014, the disclosures of which are expressly incorporated by reference herein.

### BACKGROUND AND SUMMARY OF THE INVENTION

The present invention relates to a drill ring for a core drill bit and to a method for producing a drill ring.

In the case of diamond tools, which are designed as core drill bits, a distinction is made between core drill bits with a continuous drill ring and segmented core drill bits with individual cutting segments. Core drill bits consist of a processing segment, a cylindrical drill shaft and a receiving segment with an insertion end. The core drill bit is fastened to the tool holder of a core drill by means of the insertion end and is driven by the core drilling device about a rotational axis during drilling operation.

Continuous drill rings are produced from a powder mixture with statistically distributed diamond particles. The powder mixture is filled into a tool mold and pressed into a green part; the green part is sintered under the temperature and pressure action to form a continuous drill ring.

In the production of cutting segments for segmented core drill bits, in the professional sector a method has been established, in which the cutting segments are constructed as green parts from encapsulated diamond particles. Individual diamond particles are enveloped by a powder mixture and form the encapsulated diamond particles. The encapsulated diamond particles are filled into a tool mold and pressed into a green part; the green parts are then sintered under the effect of temperature and pressure to produce finished cutting segments.

The object of the present invention is to apply the technology of the encapsulated diamond particles to continuous drill rings and to, with the drill rings produced in this way, improve the processing quality achievable in comparison to drill rings with statistically distributed diamond particles.

According to the invention, it is provided with the drill ring that the ring segments are connected to one another at the side edges. The drill ring is constructed from at least two ring segments, which consist of a sintered powder mixture and diamond particles. In this case, the drill ring is not constructed as a continuous drill ring, but is composed of two or more ring segments, which are connected to one another at the side edges.

In a preferred variant, the drill ring comprises a number of n, n≧1 first ring segments and n second ring segments, the first and second ring segments being arranged alternately one behind the other in a circumferential direction of the drill ring. The construction of the drill ring from the first and second ring segments allows adaptation to different substrates which are to be machined. In the case of core drilling in concrete materials with embedded rebar, which are also referred to as reinforced concrete materials, a drill ring encounters, for example, different substrates in the form of concrete and rebar.

Particularly preferably, the first ring segments are constructed from a sintered first powder mixture and first diamond particles, and the second ring segments are constructed from a sintered second powder mixture and second diamond particles. The properties of the first ring segments can be adapted to a first substrate, for example concrete, and the properties of the second ring segments can be adapted to a second substrate, for example rebar. The properties of the ring segments can be adjusted by means of the powder mixture and the diamond particles. In the case of the diamond particles, the average diamond diameter, the diamond distribution and the number of diamond particles can be changed.

Particularly preferably, the first powder mixture of the first ring segments and the second powder mixture of the second ring segments are identical. Particularly preferably, the first diamond particles of the first ring segments and the second diamond particles of the second ring segments have the same diamond distribution and the same mean diamond diameter. The use of the same powder mixture and the same diamond particles for the first and second ring segments can reduce the complexity of the apparatus during production of the drill ring; only one powder mixture and one variety of diamond particles are required.

In a preferred embodiment, at least one water slot is provided between the ring segments. During processing with the drill ring, coolant must be transported to the processing site; the cooling liquid flows over the water slot to the processing point and ensures sufficient cooling of the drill ring.

More preferably, the at least one water slot extends over a height between ⅓ and ⅚ of the total height of the drill ring. For drill rings that are welded to the drill shaft, the attachment area is constructed without diamonds and is unsuitable for processing. The matrix zone, which is provided with diamond particles and is approximately ⅚ of the total height of the drill ring, is suitable for the processing of substrates.

Particularly preferably, the height of the at least one water slot is set to ⅔ of the total height of the drill ring. At a proportion of ⅔ of the total height, sufficient strength of the finished drill ring can be ensured. During processing with the drill ring, coolant must be transported to the processing site; therefore the water slots in the drill ring are designed to be as long as possible.

Particularly preferably, the ring segments have one or more bores which connect the inside and outside of the drill ring. The bore is particularly preferably at least partially arranged below the at least one water slot. The additional bore ensures sufficient cooling of the drill ring when the at least one water slot is removed.

The method according to the invention for producing a continuous drill ring comprises the steps:
at least two green parts are composed of encapsulated diamond particles, diamond particles being coated by a powder mixture,
the green parts are formed into ring segments under pressure action and
the ring segments are annularly assembled and sintered under temperature action to form a continuous drill ring.

The method according to the invention comprises three process segments using different technologies. In the method according to the invention, the drill ring is not constructed as a continuous drill ring, but is composed of two or more ring segments, which are joined by sintering.

In the first process segment, a plurality of green parts is formed from encapsulated diamond particles, diamond particles being enveloped by a powder mixture and forming encapsulated diamond particles. The term “powder mixture” is used to summarize fine-grained powder mixtures and granulated powder mixtures. Iron, cobalt and/or bronze powders can be used as the powder mixture; by adding additives such as tungsten carbide, the properties of the drill rings (wear resistance, service life, cutting ability) can be influenced. In addition, the composition of the powder mixture has an influence on the sintering temperature. The term “diamond particles” is used to summarize individual diamond particles and coated diamond particles.

The green parts have the geometric shape of a straight prism with a polygonal ground surface. The prism-shaped green parts are formed into ring segments in the second process segment under pressure. The forming of the green parts takes place at temperatures below the melting temperature of the powder mixture. In the third process segment, the ring segments are annularly assembled and sintered under temperature action to form a continuous drill ring. In the sintering of the ring segments, on the one hand, a compression of the individual ring segments takes place and on the other hand a connection between adjacent ring segments.

Cold forming, hot pressing and comparable processes are suitable as forming processes. During cold pressing, a green part is brought into the predetermined shape under high pressure. In a cold press, the material did heat up, although the forming takes place in a temperature range in which no recrystallization occurs; the material deforms without the strength significantly decreasing. In hot pressing, which is also referred to as drop forging, a green part is brought into its final shape under high pressure and the addition of heat. In addition to the shape, the forging section changes its material structure; it becomes stronger and thus obtains a denser structure and a homogeneous surface.

Sintering is a process for the production of materials in which a powder or a green part (pressed powder) is heated to temperatures below the melting temperature in order to increase the strength by joining the individual powder particles. The sintering process takes place in three stages in which the porosity and the volume of the green part are markedly reduced. In the first stage of the sintering, only the densification of the green part takes place, while in the second stage the open porosity is markedly reduced. The strength of the sintered bodies is based on the sintered compounds formed in the third stage (fusions between the powder particles), which are caused by surface diffusion between powder particles. Hot pressing is a special sintering process in which external pressure is applied in addition to temperature.

In a preferred variant, the drill ring is constructed from a number of n, n≧1 first green parts which are formed into first ring segments, and n second green parts which are formed into second ring segments, the first and second ring segments being arranged along a circumferential direction of the first ring segment of the drill ring alternately one behind the other. The production of the drill ring from first and second green parts allows the drill ring to be adapted to different substrates to be machined, for example on concrete and rebar in reinforced concrete materials.

Particularly preferably, the first green parts are produced from encapsulated first diamond particles which contain a first powder mixture and first diamond particles, and the second green parts are produced from encapsulated second diamond particles which contain a second powder mixture and second diamond particles. The adaptation of the drill ring to the substrate to be treated can be carried out by selecting the powder mixture and selecting the diamond particles. In the case of the powder mixture, the composition of the materials can be varied; in the case of the diamond particles, the average diamond diameter, the diamond distribution and the number of the diamond particles can be varied.

In an alternative variant, the drill ring is constructed from a number of n≧2 equal green parts, the green parts being formed into ring segments and arranged one behind the other along a circumferential direction of the drill ring. The use of the same green parts can reduce the complexity of the apparatus during the construction of the green parts; only one powder mixture and one variety of diamond particles are required.

The green parts have the geometric shape of a straight prism with a polygonal ground surface. The rectangular base surfaces, pentagonal base surfaces and hexagonal base surfaces are suitable as base surfaces.

In a first variant, the green parts are constructed with rectangular base surfaces. The rectangular base is the simplest geometry for producing drill rings from multiple ring segments. The ring segments are joined to the adjacent ring segments at the side edges.

In a second variant, the green parts are constructed with pentagonal base surfaces, the base surfaces having a rectangle and a trapezoid with two right interior angles. In the region of the inclined trapezoidal limb, a water slot is produced during sintering with the adjacent ring segment. With such a pentagonal base surface, a number of n water slots are produced in a drill ring with 2n, n≧1 ring segments.

In a third variant, the green parts are constructed with hexagonal base surfaces, the bases having a rectangle and an isosceles trapezoid. In the region of the inclined legs of the trapezoid, water slots are produced during sintering with the adjacent ring segments. With such a hexagonal base surface, a number of n water slots are generated in a drill ring with n, n≧2 ring segments.

In a preferred further development, the ring segments are subjected to temperature and pressure action during sintering. In sintering processes with temperature and pressure action, such as hot pressing, sintering proceeds faster and at a lower temperature than in sintering processes without pressure action, such as free sintering. Since thermal diamond damage already occurs at 600° C., a lower sintering temperature can be a qualitative advantage.

Particularly preferably, the ring segments are subjected to additional external shaping by the pressure action during sintering. Special roof shapes have proven suitable for the treatment of various substrates. These roof shapes can be produced by pressure during sintering.

Embodiments of the invention are described below with reference to the drawings. This is not intended to illustrate the exemplary embodiments to scale, but the drawings are executed schematically and/or slightly distorted. With regard to supplements to the teachings directly recognizable from the drawings, reference is made to the relevant prior art. It should be understood that various modifications and changes in the form and detail of an embodiment may be made without departing from the general idea of the invention. The features of the invention disclosed in the description, the drawings as well as the claims may be essential both individually and in any combination for the further development of the invention. Moreover, all combinations of at least two of the features disclosed in the description, the drawings and/or the claims fall within the scope of the invention. The general idea of the invention is not restricted to the exact form or detail of the preferred embodiment shown and described below, or is restricted to an object which would be limited in comparison to the subject matter asserted in the claims. In the case of given design ranges, values within the limits mentioned are also to be disclosed as limiting values and can be used and claimed as desired. For the sake of simplicity, reference numerals are subsequently used below for identical or similar parts or parts with the same or similar function.

### BRIEF DESCRIPTION OF THE DRAWINGS

FIG. 1 illustrates a core drill bit consisting of a drill ring, a cylindrical drill shaft and a receiving segment;

FIG. 2 illustrates a drill ring according to the invention with four ring segments and four water slots between the ring portions;

FIGS. 3A-D illustrate the production of the drill ring of FIG. 2 of first and second green parts with a hexagonal base surface (FIG. 3A), wherein the green parts are formed into first and second ring segments (FIG. 3B), the ring segments are arranged alternately one behind the other (FIG. 3C) and sintered to a continuous drill ring (FIG. 3D); and

FIGS. 4A-C illustrate green parts with a rectangular base surface (FIG. 4A), a pentagonal base surface (FIG. 4B) and a hexagonal base surface (FIG. 4C).

### DETAILED DESCRIPTION OF THE DRAWINGS

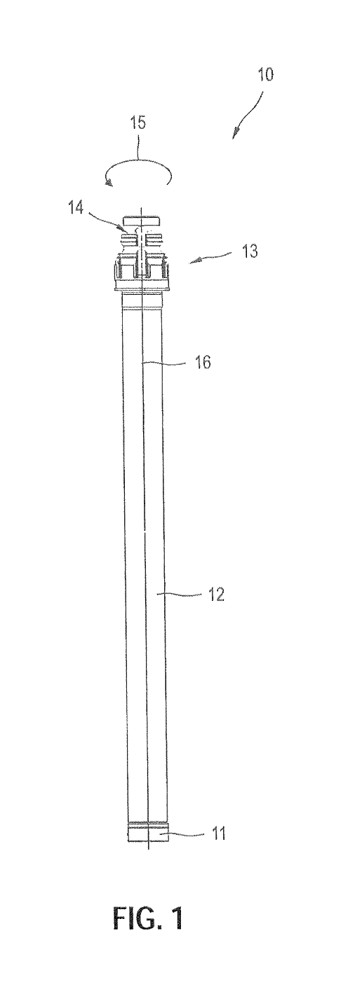

FIG. 1 shows a core drill bit 10 with a drill ring 11, a cylindrical drill shaft 12 and a receiving segment 13 with an insertion end 14. The core drill bit 10 is fastened via the insertion end 14 in the tool receptacle of a core drilling device and during drilling operation is driven by the core drilling device in a rotary direction 15 about a rotary axis 16, wherein the axis of rotation 16 is coaxial with the cylinder axis of the core drill bit 10.

The drill ring 11 is welded, brazed, or screwed to the drill shaft 12, or fixed to the drill shaft 12 in another suitable manner of attachment. In order to be able to weld the drill ring 11 with the drill shaft 12, the connecting area between the drill ring 11 and the drill shaft 12 must be made of a weldable material and must not contain diamonds, as diamonds cannot be welded.

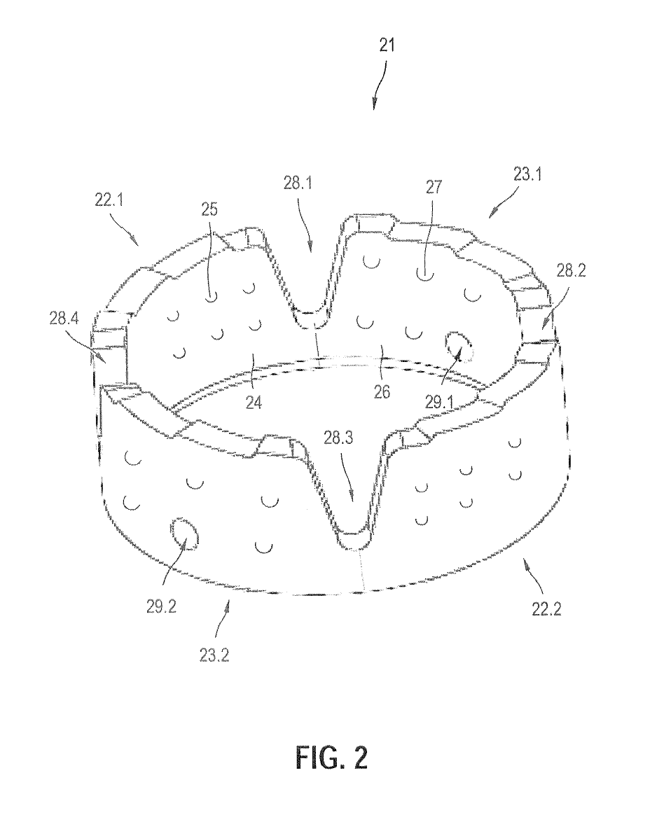

FIG. 2 shows a first embodiment of a drill ring 21 according to the invention, composed of four ring segments. The ring segments can be divided into two first ring segments 22.1, 22.2 and two second ring segments 23.1, 23.2 which are arranged alternately one behind the other along a circumferential direction of the drill ring 21. The first ring segments 22.1, 22.2 consist of a first powder mixture 24 and first diamond particles 25, and the second ring segments 23.1, 23.2 consist of a second powder mixture 26 and second diamond particles 27.

Four water slots 28.1, 28.2, 28.3, 28.4 are formed between the ring segments 22.1, 23.1, 22.2, 23.2, via which a cooling liquid is transported to the processing site. The water slots 28.1-28.4 extend over a height of approximately ⅔ of the total height of the drill ring 21. In order to ensure the operational capability of the drill ring 21 even if the water slots 28.1-28.4 are removed, the drill ring 21 additionally has two bores 29.1, 29.2, via which cooling liquid is transported to the processing site.

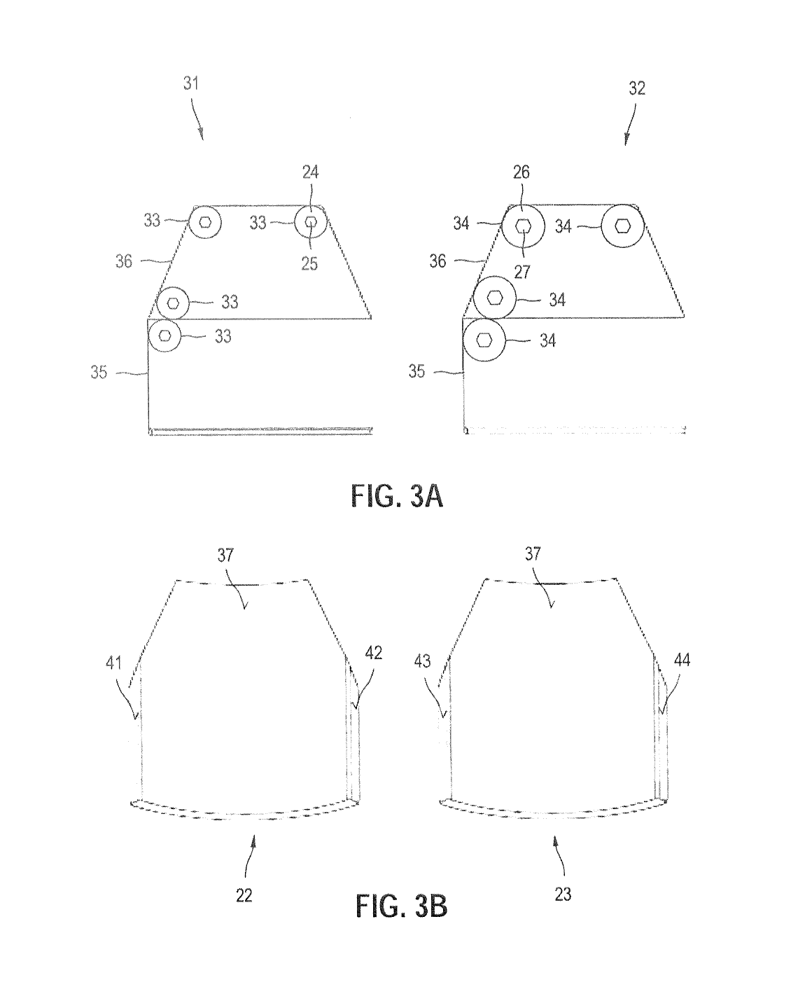

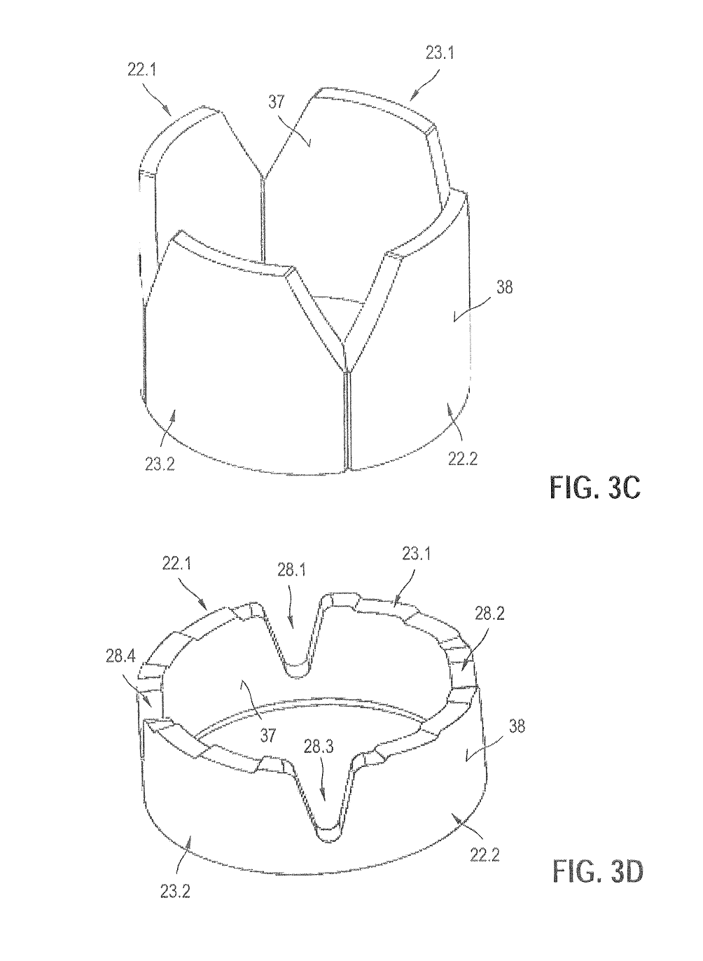

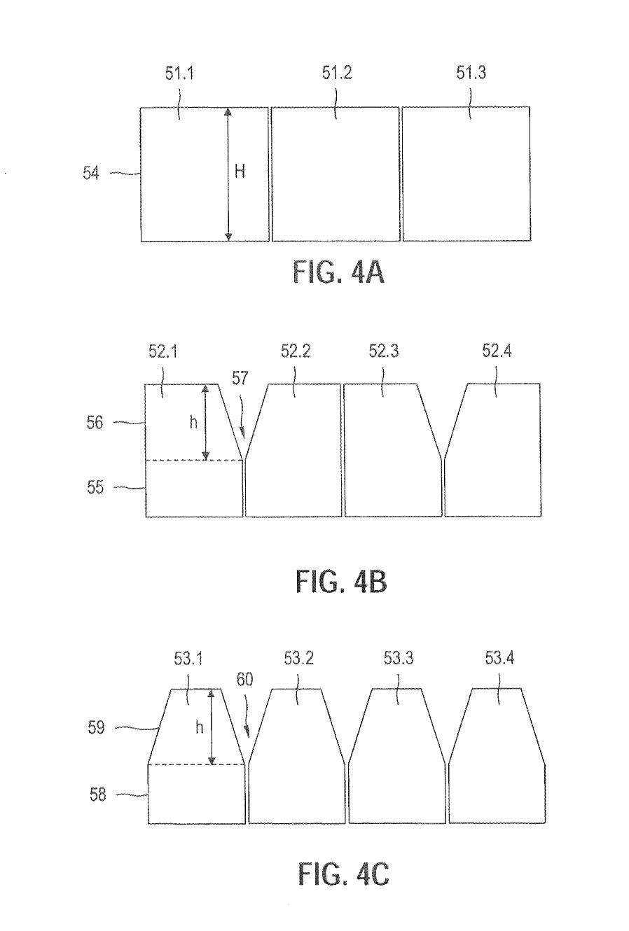

FIGS. 3A-D show the fabrication of the drill ring 21 of FIG. 2 from two first green parts 31 and two second green parts 32 (FIG. 3A), which are formed into the first ring segments 22.1, 22.2 and second ring segments 23.1, 23.2 (FIG. 3B). The ring segments are alternately arranged one behind the other along the circumferential direction of the drill ring 21 (FIG. 3C) and sintered under temperature and pressure action to form a continuous drill ring (FIG. 4D).

FIG. 3A shows the first green part 31, which is constructed of the first powder mixture 24 and the first diamond particles 25, and the second green part 32, which is constructed of the second powder mixture 26 and the second diamond particles 27. The first diamond particles 25 are enveloped by the first powder mixture 24 and form first encapsulated diamond particles 33 and the second diamond particles 27 are enveloped by the second powder mixture 26 and form second encapsulated diamond particles 34. The base surface of the green parts 31, 32 is hexagonal and consists of a rectangle 35 and an adjacent isosceles trapezoid 36. In the region of the legs of the trapezoid, the water slots 28.1-28.4 are formed during sintering by additional pressure action, via which the cooling liquid is transported to the processing site.

FIG. 3B shows the first ring segment 22, which was created from the first green part 31 of FIG. 3A under pressure action, and the second ring segment 23 consisting of the second green part 32 of FIG. 3A under pressure action. The inner sides 37 of the ring segments 22, 23 have a concave curvature, while the opposite outer sides 38 have a convex curvature.

The first ring segment 22 has first and second side edges 41, 42 which are joined to a first and second side edge 43, 44 of the second ring segment 23 during sintering. The first side edge 41 of the first ring segment 22 is connected to the second side edge 44 of the second ring segment 23, and the second side edge 42 of the first ring segment 22 is connected to the first side edge 43 of the second ring segment 23. In the drill ring 21 with two first and second ring segments 22.1, 22.2, 23.1, 23.2, the first and second side edges of the adjacent ring segments are connected to each other.

FIG. 3C shows the first and second ring segments 22.1, 22.2, 23.1, 23.2 arranged one behind the other along the circumferential direction of the drill ring 21 and adjoining one another with the side edges 41, 42, 43, 44. The ring segments 22.1, 23.1, 22.2, 23.2 form a continuous drill ring and, in the arrangement shown in FIG. 3C, processed further in a hot press.

FIG. 3D shows the drill ring after the hot pressing. During hot pressing, the ring segments 22.1, 23.1, 22.2, 23.2 are subjected to temperature and pressure action. The temperature action ensures that the powder mixture 24, 26 is sintered in the ring segments and the ring segments 22.1, 23.1, 22.2, 23.2 are connected to one another at the side edges 41, 42, 43, 44. Pressure in the axial direction causes compression of the ring segments, which leads to densification of the ring segments. Hot pressing is carried out in a die which defines the final shape of the drill ring 21.

In the method according to the invention, a drill ring is constructed from a plurality of green parts, which are formed into ring segments and are sintered to form a continuous drill ring; polygonal base surfaces are a suitable geometry for the green parts. FIGS. 4A-C show green parts 51 with a rectangular base surface (FIG. 4A), green parts 52 with a pentagonal base surface (FIG. 4B) and green parts 53 with a hexagonal base surface (FIG. 4C).

The rectangular base surface 54 of the green parts 51 represents the simplest geometry for producing drill rings from a plurality of ring segments. In the exemplary embodiment of FIG. 4A, three identical green parts 51.1, 51.2, 51.3 are used to produce a continuous drill ring.

The pentagonal base surface of the green parts 52 can be divided into a rectangle 55 and a trapezoid 56 with two right interior angles. In the region of the inclined leg of the trapezoid, a water slot 57 is produced during sintering with the adjacent ring segment. A number of n water slots 57 are produced with such a pentagonal base surface for a drill ring with 2n, n≧1 ring segments.

The hexagonal base surface of the green parts 53 can be divided into a rectangle 58 and an isosceles trapezoid 59. In the region of the inclined trapezoidal legs, water slots 60 are produced during sintering with the adjacent ring segments. With such a hexagonal base surface, a number of n water slots 60 are generated in a drill ring with n, n≧2 ring segments.

1.-17. (canceled)

18. A drill ring for a core drill bit, comprising:
at least two ring segments constructed from a sintered powder mixture and diamond particles;
wherein the at least two ring segments are connected to each other at respective side edges.

19. The drill ring according to claim 18, wherein the drill ring includes n≧1 first ring segments and n second ring segments and wherein the first and the second ring segments are disposed alternately one behind the other along a circumferential direction of the drill ring.

20. The drill ring according to claim 19, wherein the first ring segments are constructed from a sintered first powder mixture and first diamond particles and wherein the second ring segments are constructed from a sintered second powder mixture and second diamond particles.

21. The drill ring according to claim 20, wherein the sintered first powder mixture and the sintered second powder mixture are identical.

22. The drill ring according to claim 20, wherein the first diamond particles and the second diamond particles have a same diamond distribution and a same mean diamond diameter.

23. The drill ring according to claim 18, wherein at least one water slot is disposed between the at least two ring segments.

24. The drill ring according to claim 23, wherein the at least one water slot extends between ⅓ and ⅚ of a total height of the drill ring.

25. The drill ring according to claim 18, wherein the at least two ring segments have a bore that connects an inner side of the drill ring to an outer side of the drill ring.

26. A method of manufacturing a drill ring for a core drill bit, comprising the steps of:
constructing at least two green parts from diamond particles that are enveloped by a powder mixture;
forming the at least two green parts into respective ring segments under pressure; and
annularly assembling the ring segments and sintering the ring segments under temperature action to form a continuous drill ring.

27. The method according to claim 26, wherein the continuous drill ring includes n≧1 first green parts which are formed into first ring segments and n second green parts which are formed into second ring segments and wherein the first and the second ring segments are disposed alternately one behind the other along a circumferential direction of the continuous drill ring.

28. The method according to claim 27, wherein the first green parts include a first powder mixture and first diamond particles and wherein the second green parts include a second powder mixture and second diamond p articles.

29. The method according to claim 26, wherein the continuous drill ring includes n≧2 equal green parts and wherein the green parts are disposed alternately one behind the other along a circumferential direction of the continuous drill ring.

30. The method according to claim 26, wherein the at least two green parts are constructed with rectangular base surfaces.

31. The method according to claim 26, wherein the at least two green parts are constructed with pentagonal base surfaces and wherein the pentagonal base surfaces have a rectangle and a trapezoid with two right interior angles.

32. The method according to claim 26, wherein the at least two green parts are constructed with hexagonal base surfaces and wherein the hexagonal base surfaces have a rectangle and an isosceles trapezoid.

33. The method according to claim 26, wherein the ring segments are subjected to pressure action during the sintering.

34. The method according to claim 33, wherein the ring segments are subjected to external shaping by the pressure action during the sintering.
